(19) United States
(12) Patent Application Publication
(10) Pub. No.: US 2010/0299042 A1
(43) Pub. Date: Nov. 25, 2010

(54) METHOD AND SYSTEM FOR ENCOURAGING VEHICLE OPERATOR COMPLIANCE

(75) Inventors: R. Bruce Brierly, Middletown, MD (US); John E. Doub, Waynesboro, PA (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: MACK TRUCKS, INC., Greensboro, NC (US)

(21) Appl. No.: 12/743,453

(22) PCT Filed: Dec. 10, 2008
(86) PCT No.: PCT/US08/13556

§ 371 Date: Aug. 10, 2010

Related U.S. Application Data
(60) Provisional application No. 61/007,364, filed on Dec. 12, 2007.

(51) Int. Cl. G06F 19/00

(52) U.S. Cl. 701/93; 701/70

(57) ABSTRACT

A method for encouraging operator compliance with vehicle functions, comprises monitoring at least one vehicle function, monitoring an operator input related to the at least one vehicle function, the vehicle function being responsive to the operator input, the operator input being selectable from at least two choices, wherein one choice is in compliance with a vehicle function requirement, and, limiting a vehicle speed if the operator input is not in compliance with the vehicle function requirement.

### FIELD OF THE INVENTION

The invention relates to systems and methods for encouraging motor vehicle operators to properly use devices related to engine or vehicle functions. More particularly, the invention relates to systems and methods that alter engine output if an operator improperly uses a vehicle or engine function, the engine output being restored when the operator corrects the function or ceases to improperly use the function.

### BACKGROUND AND SUMMARY OF THE INVENTION

Vehicle warning and status signaling devices are known. There are systems that provide a lighted symbol, which may flash if the condition needs urgent attention. Other systems will shut down an engine to prevent damage if a highly urgent condition exists, such as sudden loss of oil pressure.

Vehicles, in particular heavy trucks, have systems that require operator attention and may require some operator action upon occurrence of an event or upon sensing some change or threshold in vehicle or engine operation. These systems may allow or request a driver input, which, if ignored, can result in damage to the vehicle.

For example, systems for treating internal combustion engine exhaust, known collectively as exhaust aftertreatment systems, require maintenance procedures, some of which can be performed by the on-board vehicle system. For example, particulate filters become clogged with particulate matter and require regeneration, and an on-board control system may signal to the operator that regeneration is being performed in an automatic system, or that regeneration is needed in a system that requires driver input to initiate.

Regeneration of a particulate filter is a process that raises the temperature of the exhaust sufficient to burn the collected particulate matter in the particulate filter. Because of the relatively high exhaust temperature during regeneration, an operator may determine that starting regeneration or allowing regeneration may not be appropriate at a particular time or location, for example, when the vehicle is entering a tunnel, is at a loading dock, or is at a fuel stop. The driver may then, if the system allows, inhibit the initiation of the regeneration, decide not to input the regeneration command, or cancel an on-going regeneration.

An operator may decide to inhibit regeneration or fail to initiate regeneration for convenience. The vehicle notice concerning regeneration may come near the end of a trip or duty cycle.

If a regeneration is not performed when requested by the vehicle system, particulate matter will continue to collect in the filter and at some point, the need for a filter regeneration will become urgent, as the clogged filter will interfere with engine operation and pose a risk of damage to the particulate filter and the engine.

As another example of operator compliance with vehicle system requests, an engine management system may determine that an engine component needs maintenance, which typically requires driving the vehicle to a maintenance facility and suspending work. An operator may be tempted to ignore such a signal to keep a schedule, but will be risking engine damage.

Some operators may not adequately comprehend the status of the system being indicated by a warning message and may fail to act or not act in compliance with the system. Others may not perceive the urgency of the message and not act in a timely manner.

What is needed, therefore, is a system and method for encouraging an operator to comply with important instructions for vehicle maintenance and other systems.

A method according to the invention includes changing a vehicle or engine operation as a signal to the operator that is difficult to ignore.

According to the invention, when an operator is not acting in compliance with a request for input or with proper use of an override system a vehicle function is changed in a way to attract the operator's attention to signal that a correction is needed. The inventors determined a vehicle speed limit to be an effective way to get the operator's attention while at the same time allowing continued vehicle operation.

According to an embodiment of the invention, vehicle speed is limited to a level below what the operator demands or expects if the operator does not comply with a message requesting maintenance or if the operator inhibits a maintenance function. The vehicle speed limitation is removed when the operator complies with the message.

An advantageous embodiment of the invention is directed to the proper use of an inhibit switch for a diesel particulate filter regeneration system. Such switches allow the operator to select for enabling regeneration and select for inhibiting regeneration. The regeneration switch remains in a selected position until manually moved by the operator. Because the regeneration switch must be manually moved, an operator can continually, perhaps unthinkingly, inhibit regeneration of the particulate filter to the detriment of the filter and engine.

According to the invention, a vehicle speed limit is imposed when the regeneration switch is in the inhibit position. The speed limit function may be active any time the regeneration switch is placed in the inhibit position. Alternatively, the speed limit function may be active if the regeneration switch is placed in the inhibit position and the switch is actually inhibiting a regeneration, that is, when the control module is attempting to initiate a regeneration. The vehicle speed limit has a magnitude sufficiently great that it is unlikely to be ignored by an operator.

According to one embodiment of the invention, a control device, which may be an engine controller or vehicle control module, will monitor the position of the regeneration switch and in response to the switch being in the inhibit position will control vehicle speed to a programmed or a calculated limit. The magnitude of the limit may be selected as appropriate for the vehicle to ensure the limit is noticed under normal vehicle operating conditions.

The speed limit is imposed to alert the driver that the manual regeneration control switch is in the inhibit position, and encourage the driver to change the switch position at the earliest appropriate opportunity. Because there are appropriate circumstances for inhibiting regeneration, to accommodate situations in which the operator cannot or should not immediately change the regeneration switch, according to another aspect of the invention, the speed limit may be sufficiently high to allow the operator to continue operation, but at the disadvantage of the limited speed.

As one example, the vehicle speed limit may be a fixed value speed limit. The value of the speed limit may be selected for the type of vehicle or the duty cycle of the vehicle.

According to another aspect of the invention, an additional, lower speed limit may be imposed if the inhibit switch is in the inhibit position upon vehicle start up.

Alternatively, the speed limit may be calculated as a percentage offset or a fixed offset of the current or demanded vehicle speed. This alternative may be particularly advantageous for use when the regeneration switch is moved to the inhibit position while the vehicle is moving. The control module will act to ramp down the vehicle speed smoothly, or decrease speed in discrete steps, according to the speed offset value. The offset may be a percentage of the current vehicle speed, or may be fixed value large enough that it likely will be noticed.

A time interval for reducing the vehicle speed by the offset value may be chosen to avoid a sudden change in speed and allow the operator opportunity to maneuver the vehicle to accommodate the reduction in speed. This may be to allow a lane change, for example. The offset may be imposed by ramping down the speed in a smooth manner over the interval.

Optionally, the vehicle speed offset may be imposed by a plurality of steps over a time interval. According to this embodiment, the first step or decrease may be configured as the largest of the plurality to help ensure the operator recognizes the controller is limiting speed. This may induce a more rapid response by the operator to correct the condition, i.e., place the regeneration switch to the regeneration enabled position.

If the operator places the regeneration switch to the inactive position, that is, the position not inhibiting regeneration, after a speed limit has been imposed, the controller will act to ramp or step vehicle speed back to the value immediately before the limit was imposed, or to a lower speed if demanded by the operator. Gradually increasing the speed, rather than allowing speed to increase in a single step, will create a time delay in resuming speed to discourage the operator from setting the regeneration inhibit switch briefly to the enable position and returning it to the inhibit position.

The controller will operate according to other programmed parameters, and will not override vehicle speed limitations that may have been set by or according to the original equipment manufacturer, the customer (if the system is capable), or legal requirements (legal speed limits).

The vehicle speed limitation values may be configured as a vehicle owner selectable parameter, or the vehicle owner may be given a range of values from which to select. Not allowing the regeneration inhibit speed limit to override other speed limits will prevent the system from being defeated by programming a negative speed offset, which could result in a higher speed if the regeneration switch is in the inhibit position.

### BRIEF DESCRIPTION OF THE DRAWING

The invention will be better understood by reference to the following detailed description in conjunction with the appended figures, in which:

FIG. 1 is a diagram showing an embodiment of a method and system of the invention for encouraging driver compliance; and,

FIG. 2 is a diagram of an alternative embodiment of the invention.

### DETAILED DESCRIPTION OF THE INVENTION

The invention is a system, which may be implemented in software for operation by on-board processors and components, and a method for encouraging operators to act in compliance with vehicle maintenance functions. The system and method can be implemented to encourage operators to avoid improper use of manual override controls and/or to encourage compliance with requests for operator input or intervention, as will be understood with reference to the following description.

An advantageous and illustrative example of an application of the invention is in conjunction with the Mack Trucks, Inc. Smart Switch™, a dashboard mounted switch that is part of a diesel particulate filter regeneration system. The system automatically initiates filter regeneration upon determining the condition of the diesel particulate filter. The Smart Switch™ is a two-position switch that allows the operator to select for enabling regeneration and select for inhibiting regeneration. The regeneration switch remains in a selected position until manually moved by the operator. According to an exemplary embodiment, the regeneration switch is a pushbutton switch with an upward, released enabled position and a down, latched active inhibit position. In the inhibit position, a lamp on the switch indicates to the operator that the switch is in the latched position. Because the regeneration switch must be manually moved, an operator can continually, perhaps unintentionally, inhibit regeneration of the particulate filter to the detriment of the filter and engine.

According to the invention, a vehicle or road speed limit is imposed when the regeneration switch is in the inhibit position. The road speed limit function may be active any time the regeneration switch is placed in the inhibit position. Alternatively, the road speed limit function may be active if the regeneration switch is placed in the inhibit position and the switch is actually inhibiting a regeneration, that is, when the control module is attempting to initiate a regeneration. The road speed limit has a magnitude sufficiently great that it is unlikely to be ignored by an operator.

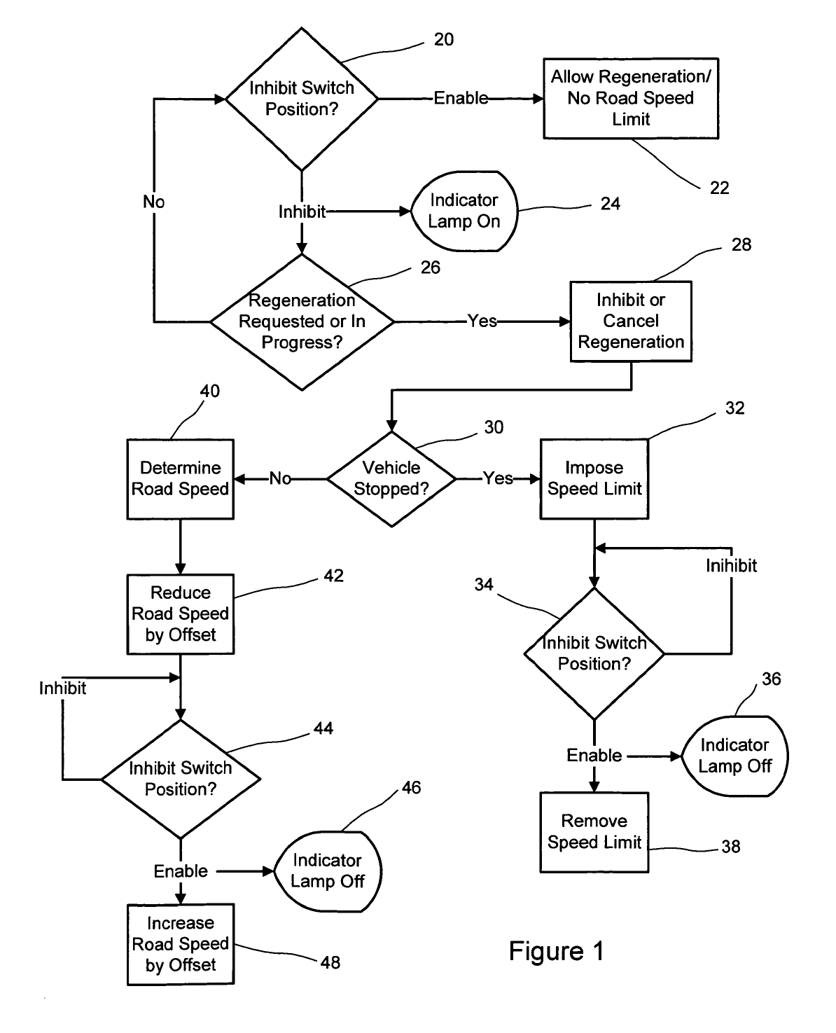

FIG. 1 illustrates an exemplary embodiment of the invention. According the invention, a control device, which may be an engine controller or vehicle control module, monitors the position of the regeneration switch 20. If the switch is in the regeneration enabled position, the control module allows a requested regeneration to proceed, and will not impose a road speed limit on the vehicle 22. If the switch is in the regeneration inhibit position, the switch indicator lamp will be lighted 24. The control module will determine if a regeneration is requested or in progress 26. If no regeneration is requested or in progress, the control module will return to monitoring the switch position 20.

If a regeneration is requested or in progress and the switch is in the inhibit position, the control module will act to inhibit or cancel the regeneration 28. The control module will then operate to encourage the driver to change the switch to allow regeneration of the filter, as follows.

The control module will determine if the vehicle is stopped or moving 30. If the vehicle is stopped, the control module will impose a road speed limit 32 to be enforced upon acceleration from stop. If the driver attempts to later move the vehicle with the switch in the inhibit position the road speed limit will alert the driver that the manual regeneration control switch is in the inhibit position, and encourage the driver to change the switch position to enabled at the earliest appropriate opportunity.

As one example, the road speed limit may be a fixed value speed limit. The value of the road speed limit may be selected for the type of vehicle or the duty cycle of the vehicle. For a highway truck, which operates at 55 miles per hour or above, a road speed limit may be, for example, 40 miles per hour. For a trash collecting truck, which has a duty cycle of repeated accelerations and decelerations, but may only reach a speed of 20 to 25 miles per hour, the road speed limit may be 5 or 10 miles per hour.

After imposing the road speed limit, the control module will return to monitoring the inhibit switch position. If the driver changes the switch to the enabled position (not inhibiting regeneration), the indicator lamp is turned off 36, and the control module removes the road speed limit 38. The control module will return to monitoring the inhibit switch.

The road speed limit is preferably removed over an interval of time rather than immediately to discourage the driver from changing the switch to the inactive position then back to the inhibit position.

If the control module determines that the vehicle is moving, that is, not stopped, the control module will then determine the road speed of the vehicle 40. The control module may impose a road speed limit as a set value as described above. Alternatively, the road speed limit may be calculated as a percentage offset or a fixed offset of the current or demanded vehicle road speed. The control module will reduce the speed 42, by ramping down the vehicle speed smoothly, or decrease speed in discrete steps, according to the speed offset value. The offset may be, for example, 20% of the current speed value or another percentage change large enough to likely be noticed by the operator. Alternatively, the offset may be fixed value large enough that it likely will be noticed, for example, 10 miles per hour.

For example, if the vehicle is moving at 60 miles per hour and the operator places the regeneration switch in the inhibit position, the controller will reduce the vehicle speed by the offset to a reduced speed, and will control the vehicle to at or below this speed. If the offset is a fixed 10 mile per hour change, the vehicle speed will be reduced from 60 miles per hour to 50 miles per hour.

The reduction in vehicle speed is intended to spur the operator to move the regeneration switch from the inhibit position to the enable position. A time interval for reducing the vehicle speed by the offset value may be chosen to avoid a sudden change in speed and allow the operator opportunity to maneuver the vehicle to accommodate the reduction in speed. This may be to allow a lane change, for example. The offset may be imposed by ramping down the speed in a smooth manner over the interval.

Optionally, the vehicle speed offset may be imposed by a plurality of steps over a time interval. According to this embodiment, the first step or decrease may be configured as the largest of the plurality to help ensure the operator recognizes the controller is limiting speed. This may induce a more rapid response by the operator to correct the condition, i.e., place the regeneration switch to the regeneration enabled position.

The control module will return to monitoring the position of the inhibit switch 44. If the switch position has not been changed by the driver, that is, the switch remains in the inhibit position, the control module continues to monitor the switch.

If the operator places the regeneration switch to the enabled position, that is, the position not inhibiting regeneration, the indicator lamp is turned off 46, and the control module will remove the road speed limit 48, and act to ramp or step vehicle speed back to the value immediately before the limit was imposed, or to a lower speed if demanded by the operator. Gradually increasing the speed, rather than allowing speed to increase in a single step, will create a time delay in resuming speed to discourage the operator from setting the regeneration inhibit switch briefly to the enable position and returning it to the inhibit position.

The control module will operate according to other programmed parameters, and will not exceed vehicle speed limitations that may have been set by or according to the original equipment manufacturer, the customer (if the system is capable), other driver demands such as a cruise control or accelerator pedal demands, or legal requirements (legal speed limits).

The vehicle speed limitation values may be configured as a vehicle owner selectable parameter, or the vehicle owner may be given a range of values from which to select. Not allowing the regeneration inhibit speed limit to exceed other speed limits will prevent the system from being defeated by programming a negative speed offset, which could result in a higher speed if the regeneration switch is in the inhibit position.

The foregoing description of the invention in conjunction with a Mack Trucks Inc. Smart Switch™ was by way of exemplary embodiment.

The invention may also be readily adapted to other vehicle systems.

For example, some vehicle regeneration control systems may include other devices or means for an operator to control the system status for inhibit, such as a touch screen or cursor navigating device for a screen display. The particular switch or selector arrangement does not change the applicability of the invention.

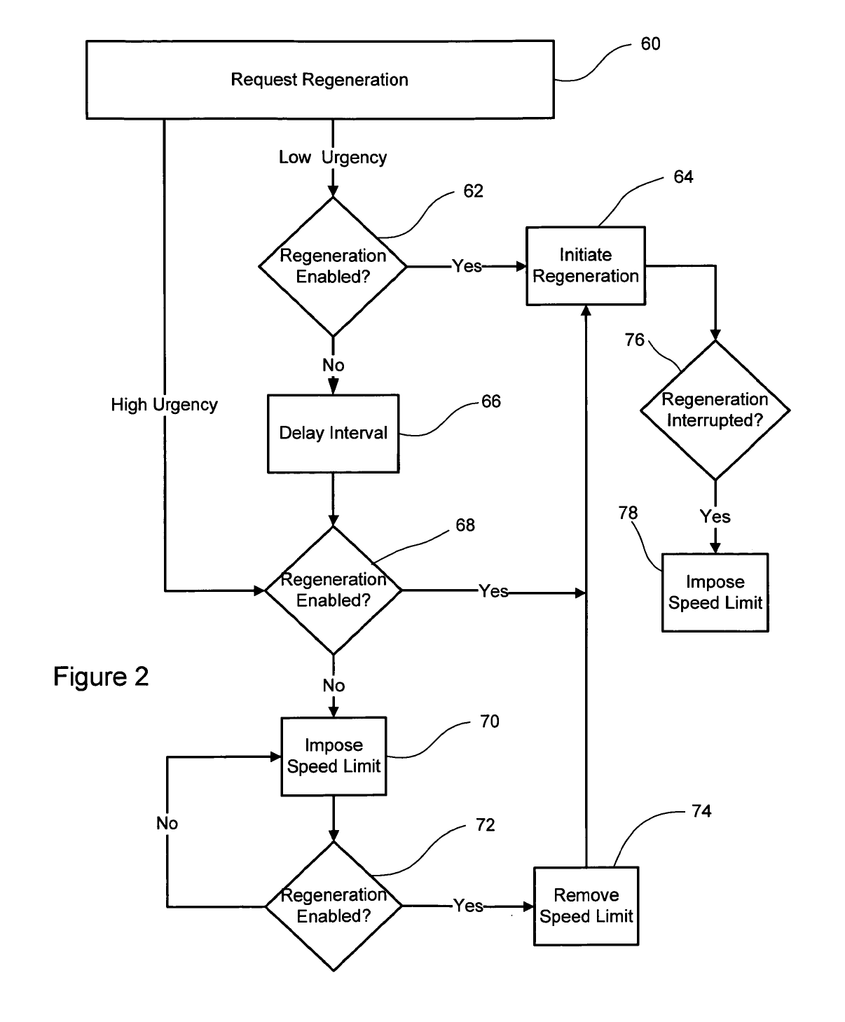

The invention may be integrated in a regeneration system that requires operator initiation of regeneration as shown in FIG. 2. For example, regeneration systems that require a parked vehicle may signal to the operator the need for regeneration so that the operator can pull off the road or otherwise to an appropriate location and initiate regeneration. A vehicle system may signal to the operator by a lamp or display screen message that a regeneration of the particulate filter is needed 60 and wait for operator input 62. Depending on the particulate load status of the filter (e.g., amount of clogging), the message may contain an indication of the urgency of the need, for example, low urgency or high urgency. As mentioned above, an operator may find it inconvenient or inappropriate to start regeneration because of vehicle location or operating status.

If the driver enables regeneration upon receipt of the signal, the system will initiate regeneration of the particulate filter 64.

According to this embodiment of the invention, if the driver does not enable regeneration and the urgency is low, the system will allow a time interval or mileage interval 66 for the operator to drive the vehicle to an appropriate location for regeneration and will monitor for the input to initiate regeneration 68. If the driver enables regeneration, the system will initiate regeneration of the filter 64. If the input is not received in the time or mileage interval, the system will impose a speed limit on the vehicle 70. The speed limit may be a set speed value, a percentage speed decrease, or an offset limit as described above.

Alternatively, the system may signal a need for regeneration according to a first level of urgency, but not impose a speed limit for the operator's failure to initiate the requested regeneration. The system will continue to monitor particulate filter status, and upon sensing a threshold according to a second level of urgency, will signal the need for regeneration, also signaling the urgency level. The system may allow a time interval for compliance before imposing a speed limit. Alternatively, for a higher level of urgency, the controller may request that regeneration be enabled 60, and if the driver does not comply 68, the controller will immediately impose a speed limit 70. Again, the speed limit may be imposed according to any of the alternatives described above.

When the controller detects that the driver has enabled regeneration 72, the speed limit may be removed 74 and the regeneration initiated.

For a regeneration system requiring the vehicle to be parked for regeneration, the system of the invention may monitor whether the regeneration is allowed to continue to completion by the operator 76. If the operator initially acts in compliance with the request for a parked regeneration, that is, parks the vehicle and initiates regeneration, but cancels the regeneration before it is completed, thus interrupting the regeneration process, the system may impose a vehicle speed limit immediately upon movement 78.

The system and method for encouraging operator compliance can also be adapted to other vehicle systems or components and requests for operator action. For example, a vehicle system may require maintenance or service and the control module will signal that information to the operator. The system will wait for an input, in this case from the service or maintenance technician, or otherwise monitor the vehicle component, for indication that the requested maintenance or service has been performed. The system will be programmed to wait for a predetermined time interval, which may be chosen according to the urgency of the need for maintenance or service. If no indication is received in the predetermined time interval, the system will then impose a speed limit.

The invention has been described in terms of preferred principles, embodiments, and methods; however, those skilled in the art will recognize that other embodiments are within the scope of the invention and equivalents method steps may be substituted without departing from the scope of the invention as defined by the appended claims.

What is claimed is:

1. A method for encouraging operator compliance with vehicle functions, comprising the steps of:
monitoring at least one vehicle function requesting an operator input;
monitoring an operator input related to the at least one vehicle function, the operator input being selectable from at least two choices, wherein one choice is in compliance with the vehicle function request; and,
limiting a vehicle speed if the operator input is not in compliance with the vehicle function request.

2. The method of claim 1, wherein the vehicle function is particulate filter regeneration and wherein the operator input not in compliance with the vehicle function is an operator input inhibiting particulate filter regeneration.

3. The method of claim 1, wherein the step of limiting the vehicle speed comprises limiting the speed to a fixed speed value.

4. The method of claim 1, wherein the step of limiting the vehicle speed comprises sensing vehicle speed, reducing vehicle speed by an offset value to a limited speed, and controlling vehicle speed to not greater than the limited speed.

5. The method of claim 1, further comprising the step of allowing a delay interval before limiting vehicle speed.

6. The method of claim 1, further comprising the step of monitoring the operator input and removing the speed limit responsive to an input in compliance with the function request.

7. The method of claim 6, wherein the step of removing the speed limit is performed over a predetermined interval of time.

8. A method for encouraging operator compliance with a vehicle exhaust aftertreatment regeneration system, comprising the steps of:
monitoring a vehicle aftertreatment function request for an operator input;
monitoring an operator input related to the vehicle aftertreatment function, the operator input being selectable from at least two choices, wherein one choice is in compliance with the request; and,
limiting a vehicle speed if the operator input is not in compliance with the function request.

9. The method of claim 8, wherein the vehicle function is particulate filter regeneration and wherein the operator input not in compliance with the vehicle function request is an operator input inhibiting regeneration.

10. The method of claim 8, further comprising the steps of:
determining that the vehicle is stopped; and,
imposing a road speed limit value on the engine controller.

11. The method of claim 10, further comprising the step of monitoring the operator input and removing the road speed limit responsive to an input in compliance with the function request.

12. The method of claim 8, further comprising the steps of:
determining that the vehicle is in motion;
determining a vehicle road speed; and,
reducing the vehicle road speed by an offset amount.

13. The method of claim 12, wherein the step of reducing the vehicle road speed comprises reducing the speed by the offset amount in at least two steps, a first step being larger than any subsequent step.

14. The method of claim 12, further comprising the step of monitoring the operator input and allowing the vehicle speed to increase the speed limit responsive to an input in compliance with the function request.

15. The method of claim 14, further wherein the step of removing the speed limit is performed over a predetermined interval of time.

16. The method of claim 8, comprising continually monitoring the operator input and removing the road speed limit responsive to an input in compliance with the function request.

17. The method of claim 8, further comprising the step of determining that the request for driver input has a low urgency, and wherein the step of limiting the vehicle speed is delayed for a predetermined interval while the step of monitoring an operator input is performed.

18. The method of claim 8, further comprising the step of determining that the request for driver input has a high urgency, and wherein the step of limiting the vehicle speed is performed immediately upon determining the driver input is not in compliance with the request.
